(19) United States
(12) Patent Application Publication
(10) Pub. No.: US 2011/0029693 A1
(43) Pub. Date: Feb. 3, 2011

(54) RESERVING PCI MEMORY SPACE FOR PCI DEVICES

(76) Inventors: Hubert Brinkmann, Spring, TX (US); Darren Cepulis, Houston, TX (US); Dave Matthews, Cypress, TX (US); Dwight Riley, Houston, TX (US); Paul Brownell, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/935,527

(22) PCT Filed: Apr. 1, 2008
(86) PCT No.: PCT/US08/59060

§ 371 Date: Sep. 29, 2010

(51) Int. Cl. G06F 3/00; G06F 13/14

(52) U.S. Cl. 710/8; 710/305

(57) ABSTRACT

Embodiments include methods, apparatus, and systems for reserving memory space for Peripheral Component Interconnect (PCI) devices. One embodiment includes a method that determines peripheral devices that are connected to a host computer through a PCI switch or PCI bridge and then presents virtual devices as being connected to the PCI switch or PCI bridge. Bus numbers and memory are reserved for the virtual devices and assigned to PCI devices that are hot plugged to the host computer.

### BACKGROUND

The Peripheral Component Interconnect or PCI Standard defines a computer bus for attaching peripheral devices to a motherboard. The PCI specification describes the physical attributes of the bus, electrical characteristics, bus timing, communication protocols, and more. A PCI Special Interest Group (PCI-SIG) maintains and governs the specifications for various PCI architectures.

When a computer initially starts, a PCI enumeration time period commences. During this time, PCI enumeration software in the computer compiles a list of all installed peripheral devices and their memory space requirements. In other words, the computer determines which peripheral devices are connected to the PCI bus. This software then creates a memory map that allocates space for all installed devices.

The memory map created may be tightly packed with no holes included for any future devices. Further, the PCI bus numbering may not leave a PCI bus for devices connected after enumeration is completed. This produces a problem for systems that can accept hot plug devices. Specifically, it can be problematic to change the memory map and the PCI bus numbering to include space for the devices that are hot plugged after enumeration. Some computer systems require that the host re-enumerate the system after a device is hot plugged.

### BRIEF DESCRIPTION OF THE DRAWINGS

FIG. 1 is a block diagram of a computer system for reserving and issuing PCI bus numbers and memory space for virtual PCI devices in accordance with an exemplary embodiment.

FIG. 2 is a flow diagram for reserving PCI bus numbers and memory space for virtual PCI devices in accordance with an exemplary embodiment.

FIG. 3 is a flow diagram for issuing reserved PCI bus numbers and memory space to hot plugged PCI devices in accordance with an exemplary embodiment.

### DETAILED DESCRIPTION

Exemplary embodiments are directed to methods, systems, and apparatus for reserving PCI memory space for PCI devices. In one embodiment, memory space is reserved for PCI devices that are hot-plugged after the computer starts and PCI enumeration occurs.

In one exemplary embodiment, downstream bridges with hot-plug capability but without any connected device will present virtual devices on the bus behind them. These virtual devices request “dummy” memory on behalf of devices that can be installed later. Once a device has been hot plugged, the downstream bridge no longer presents a virtual device. The “dummy” memory space originally requested by the virtual device then becomes available to be assigned to the hot-plugged device. Further, the PCI bus assigned to the virtual device becomes available for the hot-plugged device.

In one embodiment, when the host initially boots the host sees or detects physical devices that are portrayed as a virtual devices by a bridge between the host and the devices. The host also sees dummy virtual devices that are just placeholders created by the bridge for later when a physical device that is portrayed as a virtual device is hot-plugged to the bridge. The physical attachment of a new device is not necessarily connected to the bridge.

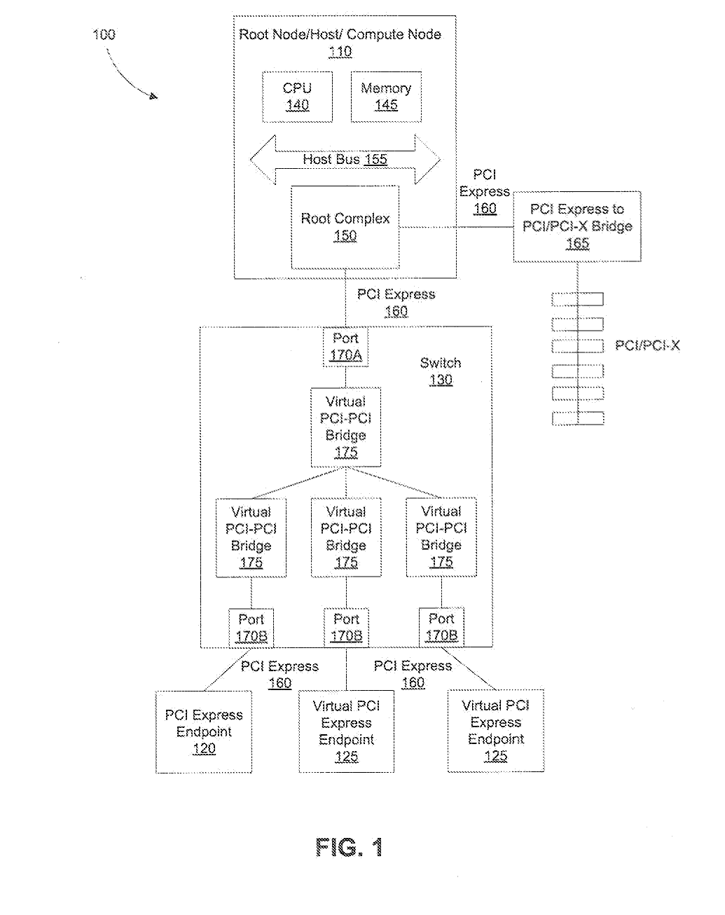

FIG. 1 is a block diagram of a computer system 100 for reserving and issuing PCI bus numbers and memory space for virtual PCI devices in accordance with an exemplary embodiment. For illustration, the computer system is shown using PCI Express architecture, but exemplary embodiments are not limited to any particular type of PCI architecture.

FIG. 1 shows a single fabric instance or hierarchy that includes a root complex, multiple endpoints (for example, Input/Output (I/O) devices), a switch, and a PCI Express to PCI/PCI-X Bridge, all interconnected via PCI Express buses or links. Specifically, a root node, compute node, or host computer 110 connects to a plurality of PCI express endpoints 120 through one or more switches 130 (one switch being shown for convenience of illustration). The root node connects to various devices (such as endpoints or endnodes, bridges, switches, etc.) through PCI Express buses or links 160. In one embodiment, one or more of the PCI Express endpoints 120 are physically connected to the switch 130. In other embodiments, one or more of the PCI Express endpoints 120 are disaggregated from the switch 130. In other words, the endpoints 120 are not physically connected to the ports 170B but disaggregated.

The root node 110 includes a CPU 140, memory 145, and root complex 150 coupled through a host bus 155. The root complex 150 connects to various virtual PCI express endpoints 125, PCI Express to PCI/PCI-X bridge 165, and switch 130 through various PCI Express buses 160. The PCI/PCI-X bridge 165 provides a connection between a PCI Express fabric and a PCI/PCI-X hierarchy.

The root complex (RC) 150 denotes the root of an I/O hierarchy that connects the CPU/memory subsystem to the I/O devices. The root complex can support one or more ports.

Each interface defines a separate hierarchy domain, and each hierarchy domain includes a single endpoint or a sub-hierarchy containing one or more switch components and endpoints. The capability to route peer-to-peer (P2P) transactions between hierarchy domains through a root complex is optional and implementation dependent. For example, an implementation can include a real or virtual switch internally within the root complex to enable full peer-to-peer (P2P) support in a software transparent way.

The root complex 150 can function or support one or more of the following: support generation of configuration requests as a requester, support the generation of I/O requests as a requester, and support generation of locked requests as a requester.

The endpoints include both virtual endpoints and actual or physical endpoints. A physical or actual endpoint is a device or collection of devices that can be a requester or completer of a PCI transaction either on its own behalf or on behalf of a distinct non-PCI device (other than a PCI device or host CPU), e.g., a PCI Express attached graphics controller, a PCI Express-USB host controller, etc. or other I/O device (such as a disk drive). By contrast, virtual endpoints represent devices that are not actually and physically present and/or connected to the computer system. Thus, the host 110 detects or believes that physical devices are connected to slots/ports in the computer system, but in reality no physical device actually exists.

As shown, the switch 130 includes a plurality of ports 170 and plurality of virtual PCI-PCI bridges 175. For illustration, switch 130 is shown with one upstream port 170A and three downstream ports 170B. The switch connects one or more physical endpoints 120 and virtual endpoints 125 through PCI links 160.

The switch follows one or more of the following rules: switches appear to configuration software as two or more logical PCI-to-PCI Bridges, a switch forwards transactions using PCI bridge mechanisms (such as address based routing), and a switch forwards various types of transaction layer packets between sets of ports.

In one embodiment, each PCI Express link 160 is mapped through a virtual PCI-to-PCI bridge structure and has a logical PCI bus associated with it. The virtual PCI-to-PCI Bridge structure can be part of a PCI Express root complex port, a switch upstream port, or a switch downstream port. A root port is a virtual PCI-to-PCI bridge structure that originates a PCI Express hierarchy domain from a PCI Express root complex. Devices are mapped into configuration space such that each will respond to a particular device number.

In one embodiment, when the host 110 initially boots the host sees or detects physical devices that are portrayed as a virtual devices (i.e., a virtual PCI Express endpoint 125) by a bridge or switch (i.e., switch 130) between the host and the devices. The host also sees the virtual PCI Express endpoints 125 as physical connected devices. These devices, however, are actually dummy virtual devices that are just placeholders created by the switch 130 for later when a physical device that is portrayed as a virtual device is hot-plugged to the bridge.

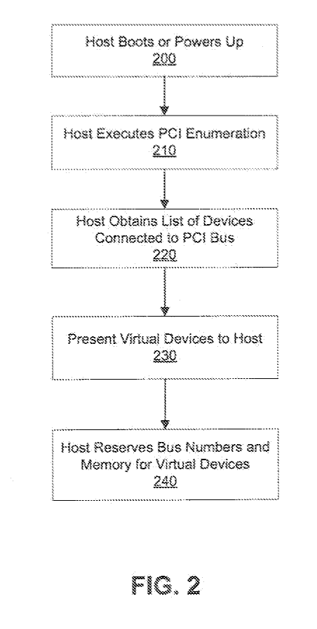

FIG. 2 is a flow diagram for reserving PCI bus numbers and memory space for virtual PCI devices in accordance with an exemplary embodiment.

According to block 200, the host computer or root node powers up. For example, the host is turned on or restarted.

According to block 210, the host executes a PCI enumeration. After the computer starts, the PCI enumeration time period commences. During this time, PCI enumeration software in the computer compiles a list of all installed peripheral devices and their memory space requirements. In other words, the computer determines which peripheral devices are actually or physically connected to the PCI bus.

In one embodiment, the computer builds an address map before booting the computer to the operation system (OS). Enumeration software determines how much memory is in the system and how much address space the I/O controllers in the system require. This map (often called a PCI resource allocation map) is a map of addresses that shows what addresses are assigned to interface cards and/or I/O controllers in the PCI slots during power-up.

According to block 220, the host obtains a list of devices that are connected to the PCI bus. For example, the host receives a list of physical or actual endpoints (such as PCI Express endpoints 120 shown in FIG. 1) connected to the system.

According to block 230, virtual endpoints are presented to the host or compute node as actual, physical endpoints. This causes the host to perform two functions according to block 240. As one function, the host reserves bus numbers for the bus that is behind the downstream bridge. As a second function, the host reserves memory in a linear memory map for the virtual devices.

The host thus creates a memory map that allocates space and bus numbers for all installed and virtual devices in the computer system. The memory map includes available space for any future devices (for example, PCI hot-pluggable devices) that are not yet connected to the PCI bus. Further, the PCI bus numbering includes available numbers for any future devices that are not yet connected to the PCI bus.

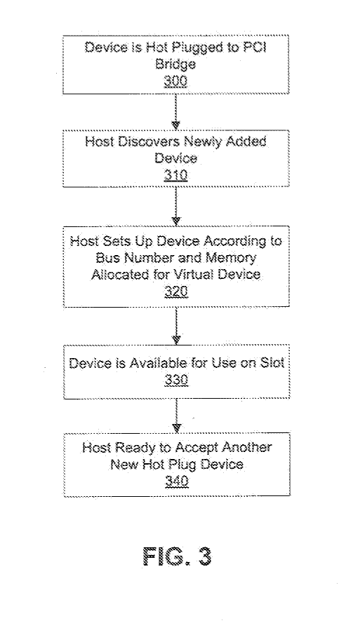

FIG. 3 is a flow diagram for issuing reserved PCI bus numbers and memory space to hot plugged PCI devices in accordance with an exemplary embodiment.

According to block 300, the one or more devices are hot plugged into the computer system. For example, an endpoint is hot plugged to a PCI bridge or switch. FIG. 1 shows examples of virtual PCI express endpoints 125 where an actual, physical device can be plugged or attached to the switch 130 after enumeration.

According to block 310, the host discovers the newly added device or endpoint. The virtual device is no longer presented to the host once the device is hot-plugged into the port or slot. In other words, the downstream bridge no longer presents the virtual device as being connected to the bridge since an actual, physical device is now connected.

Next, according to block 320, the host sets up the newly added device according to one or more bus numbers and memory previously allocated for virtual devices during enumeration. For example, the host provides the device with bus number assigned to the port or slot and provides the corresponding memory space for that port or slot.

Once the device is provided with a bus number and memory space, the device is available for use in the port or slot according to block 330. The host is now ready to accept another new hot plug device in another port or slot and then proceed back to block 300.

This process cures the problem for systems that can accept hot plug devices. Specifically, when new devices are added the memory map is not changed since it already includes unused or available space for the newly added hot-plugged devices. As such, the computer system is not required to reboot or re-enumerate the system after a device is hot plugged. Thus, exemplary embodiments allow hot plugging of devices in a shared I/O system without requiring a full re-enumeration of the host.

Definitions: As used herein and in the claims, the following words and terms are defined as follows:

The word “bridge” means a device that connects two local area networks (LANs) or segments of a LAN using a same protocol (for example, Ethernet or token ring). For example, a bridge is a function that virtually or actually connects a PCI/PCI-X segment or PCI Express port with an internal component interconnect or with another PCI/PCI-X bus segment or PCI Express port.

The term “configuration space” means address spaces within the PCI architecture. Packets with a configuration space address are used to configure a function (i.e., an address entity) within a device.

The word “downstream” means a relative position of an interconnect/system element (port/component) that is farther from the root complex. For example, the ports on a switch that are not the upstream port are downstream ports. All ports on a root complex are downstream ports. Thus, downstream also includes a direction of information flow where the information is flowing away from the root complex.

The word “endpoint” or “endnode” means a device (i.e., an addressable electronic entity) or collection of devices that operate according to distinct sets of rules.

The word “hot-plug” or “hot swap” or the like means the ability to remove and replace an electronic component of a machine or system while the machine or system continues to operate. For example, hot swapping enables one or more devices (for example, hard drives) to be exchanged or serviced without impacting operation of an overall blade or enclosure in which the device is located. For instance, in the event of a failure, the individual hard drive is removed from the blade and replaced with a new or different hard drive. The new hard drive is connected to the blade without disrupting continuous operation of the blade while it remains in the enclosure.

The acronym “PCI” means Peripheral Component Interconnect. The PCI specification describes the physical attributes of the bus, electrical characteristics, bus timing, communication protocols, and more. A PCI Special Interest Group (PCI-SIG) maintains and governs the specifications for various PCI architectures.

The word “port” logically means an interface between a component and a link (i.e., a communication path between two devices), and physically means a group of transmitters and receivers located on a chip that define a link.

The term “root complex” means a device or collection of devices that include a host bridge and one or more ports. For example, a host computer has a PCI to host bridging function that is a root complex. The root complex provides a bridge between a CPU bus (such as hyper-transport) and PCI bus.

The term “root node” means a host-computer, computer system, or server.

The word “switch” means a device or collection of devices that connects two or more ports to allow packets to be routed from one port to another. To configuration software, a switch appears as a collection of virtual PCI-to-PCI bridges.

The word “virtual” means not real and distinguishes something (for example, a physical device) that is merely conceptual from something that has physical reality. As one example, a host can see or detect a virtual endpoint as being a physical endpoint when in fact a physical endpoint is not actually connected to the bus (the device being imaginary but detected or believed to exist by the host). The opposite of virtual is real or physical.

The word “upstream” means a relative position of an interconnect/system element (port/component) that is closer to the root complex. For example, the ports on a switch that are closet topologically to the root complex are upstream ports. For example, the port on component that contains only an endpoint is an upstream port. Upstream also includes a direction of information flow where the information is flowing toward the root complex.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
establishing a list of peripheral devices that are actually connected to a host computer through a Peripheral Component Interconnect (PCI) switch or PCI bridge;
presenting virtual devices as being connected to the PCI switch or the PCI bridge;
reserving bus numbers and memory for the virtual devices; and
assigning the bus numbers and the memory to PCI devices that are hot plugged to the host computer.

2) The method of claim 1 further comprising, presenting downstream bridges to the host computer as having PCI devices connected to the downstream bridges, wherein the PCI devices connected to the downstream bridges are the virtual devices.

3) The method of claim 1 further comprising, requesting memory during an enumeration process of the host computer, wherein the memory being requested is for the virtual devices.

4) The method of claim 1 further comprising, discontinuing to present a virtual device to the host computer after an actual device is hot plugged to a port or slot where the virtual device was present.

5) The method of claim 1 further comprising, assigning memory space previously assigned to a virtual device to one of the PCI devices that are hot plugged to the host computer.

6) The method of claim 1 further comprising, assigning memory space previously assigned to a virtual device to one of the PCI devices that are hot plugged to the host computer.

7) The method of claim 1 further comprising, allowing hot plugging of devices into a shared Input/Output (I/O) system without requiring the host computer to perform an enumeration to establish peripheral devices connected to the I/O system.

8) A tangible computer readable storage medium having instructions for causing a computer to execute a method, comprising:
determining peripheral devices that are physically connected to a root node by one or more Peripheral Component Interconnect (PCI) switches or PCI bridges;
presenting virtual devices as being connected to the PCI switches or the PCI bridges;
reserving bus numbers and memory for virtual PCI devices that are presented to the root node as being connected to the PCI switches or the PCI bridges; and
assigning the bus numbers and the memory to PCI devices that are hot plugged to the root node.

9) The tangible computer readable storage medium of claim 8 further comprising, discontinuing to present a virtual PCI device to the root node after an actual device is hot plugged to a bridge where the virtual PCI device was present.

10) The tangible computer readable storage medium of claim 8 further comprising, creating a memory map that provides space for both the peripheral devices that are physically connected to the root node and the virtual PCI devices that are presented to the root node as being connected to the PCI switches and the PCI bridges.

11) The tangible computer readable storage medium of claim 8 further comprising, determining when a peripheral device is hot-plugged to a switch or bridge that was previously assigned to a virtual PCI device.

12) The tangible computer readable storage medium of claim 8 further comprising, presenting downstream bridges to the root node as having PCI devices connected to the downstream bridges, wherein the PCI devices connected to the downstream bridges are the virtual PCI devices.

13) The tangible computer readable storage medium of claim 8 further comprising, requesting memory during an enumeration process of the root node, wherein the memory being requested is for the virtual PCI devices.

14) The tangible computer readable storage medium of claim 8 further comprising, assigning memory space previously assigned to a virtual PCI device to one of the PCI devices that are hot plugged to the root node.

15) The tangible computer readable storage medium of claim 8 further comprising, assigning memory space previously assigned to a virtual PCI device to one of the PCI devices that are hot plugged to the root node.

16) The tangible computer readable storage medium of claim 8 further comprising, allowing hot plugging of devices into a shared Input/Output (I/O) system without requiring the root node to perform an enumeration to establish peripheral devices connected to the I/O system.

17) A computer system, comprising:
a memory that stores an algorithm; and
a processor that executes the algorithm to:
determine peripheral devices that are connected to a host computer by one or more Peripheral Component Interconnect (PCI) switches or PCI bridges;
present virtual devices as being connected to the PCI switches or the PCI bridges;
reserve bus numbers and memory for virtual devices that are presented to the host computer as being connected to the PCI switches or bridges; and
assign the bus numbers and the memory to PCI devices that are hot plugged to the host computer.

18) The computer system of claim 17, wherein the bus numbers occur for a bus that is behind a downstream bridge.

19) The computer system of claim 17, wherein the processor further executes the algorithm to reserve the memory in a linear memory map for the PCI devices that are hot plugged to the host computer.

20) The computer system of claim 17, wherein the processor further executes the algorithm to:
assign the memory space previously assigned to a virtual device to one of the PCI devices that are hot plugged to the host computer; and
assign the memory space previously assigned to a virtual device to one of the PCI devices that are hot plugged to the host computer.
